(19) United States
(12) Patent Application Publication
(10) Pub. No.: US 2013/0158999 A1
(43) Pub. Date: Jun. 20, 2013

(54) VOICE RECOGNITION APPARATUS AND NAVIGATION SYSTEM

(71) Applicants: Yuzo Maruta, Tokyo (JP); Jun Ishii, Tokyo (JP)

(72) Inventors: Yuzo Maruta, Tokyo (JP); Jun Ishii, Tokyo (JP)

(73) Assignee: Mitsubishi Electric Corporation, Tokyo (JP)

(21) Appl. No.: 13/819,298

(22) PCT Filed: Nov. 30, 2010
(86) PCT No.: PCT/JP2010/006972

§ 371 Date: Feb. 26, 2013

(51) Int. Cl. G10L 15/04

(52) U.S. Cl. CPC G10L 15/04
USPC 704/252

(57) ABSTRACT

A voice recognition apparatus creates a voice recognition dictionary of words which are cut out from address data constituting words that are a voice recognition target, and which have an occurrence frequency not less than a predetermined value, compares a time series of acoustic features of an input voice with the voice recognition dictionary, selects the most likely word string as the input voice from the voice recognition dictionary, carries out partial matching between the selected word string and the address data, and outputs the word that partially matches as a voice recognition result.

### TECHNICAL FIELD

The present invention relates to a voice recognition apparatus applied to an onboard navigation system and the like, and to a navigation system with the voice recognition apparatus.

### BACKGROUND ART

For example, Patent Document 1 discloses a voice recognition method based on large-scale grammar. The voice recognition method converts input voice to a sequence of acoustic features, compares the sequence with a set of acoustic features of word strings specified by the prescribed grammar, and recognizes that the one that best matches a sentence defined by the grammar is the input voice uttered.

### PRIOR ART DOCUMENT

### Patent Document

Patent Document 1: Japanese Patent Laid-Open No. 7-219578.

### DISCLOSURE OF THE INVENTION

### Problems to be Solved by the Invention

In Japan and China, since kanji and the like are used, there are various characters. In addition, considering a case of executing voice recognition of an address, since addresses sometimes include condominium names which are proper to a building, if a recognition dictionary contains full addresses, the capacity of the recognition dictionary becomes large, which offers a problem of bringing about deterioration in the recognition performance and prolonging the recognition time.

In addition, as for the conventional technique typified by the Patent Document 1, when characters used are diverse and proper names such as condominium names are contained in a recognition target, its grammar storage and word dictionary storage must have very large capacity, thereby increasing the number of accesses to the storages and prolonging the recognition time.

The present invention is implemented to solve the foregoing problems. Therefore it is an object of the present invention to provide a voice recognition apparatus capable of reducing the capacity of the voice recognition dictionary and speeding up the recognition processing in connection with it, and to provide a navigation system incorporating the voice recognition apparatus.

### Means for Solving the Problems

A voice recognition apparatus in accordance with the present invention comprises: an acoustic analyzer unit for carrying out acoustic analysis of an input voice signal to convert the input voice signal to a time series of acoustic features; a vocabulary storage unit for recording words which are a voice recognition target; a word cutout unit for cutting out a word from the words stored in the vocabulary storage unit; an occurrence frequency calculation unit for calculating an occurrence frequency of the word cut out by the word cutout unit; a recognition dictionary creating unit for creating a voice recognition dictionary of words with the occurrence frequency not less than a predetermined value, the occurrence frequency being calculated by the occurrence frequency calculation unit; an acoustic data matching unit for comparing the time series of acoustic features of the input voice acquired by the acoustic analyzer unit with the voice recognition dictionary created by the recognition dictionary creating unit, and for selecting a most likely word string as the input voice from the voice recognition dictionary; and a partial matching unit for carrying out partial matching between the word string selected by the acoustic data matching unit and the words the vocabulary storage unit stores, and for selecting as a voice recognition result a word that partially matches to the word string selected by the acoustic data matching unit from among the words the vocabulary storage unit stores.

### Advantages of the Invention

According to the present invention, it offers an advantage of being able to reduce the capacity of the voice recognition dictionary and to speed up the recognition processing in connection with that.

### BRIEF DESCRIPTION OF THE DRAWINGS

FIG. 1 is a block diagram showing a configuration of a voice recognition apparatus of an embodiment 1 in accordance with the present invention;

FIG. 2 is a flowchart showing a flow of the creating processing of a voice recognition dictionary in the embodiment 1 and is a diagram showing a data example handled in the individual steps;

FIG. 3 is a diagram showing an example of the voice recognition dictionary used in the voice recognition apparatus of the embodiment 1;

FIG. 4 is a flowchart showing a flow of the voice recognition processing of the embodiment 1 and is a diagram showing a data example handled in the individual steps;

FIG. 5 is a block diagram showing a configuration of the voice recognition apparatus of an embodiment 2 in accordance with the present invention;

FIG. 6 is a flowchart showing a flow of the creating processing of a voice recognition dictionary of the embodiment 2 and is a diagram showing a data example handled in the individual steps;

FIG. 7 is a diagram showing an example of the voice recognition dictionary used in the voice recognition apparatus of the embodiment 2;

FIG. 8 is a flowchart showing a flow of the voice recognition processing of the embodiment 2 and is a diagram showing a data example handled in the individual steps;

FIG. 9 is a diagram illustrating an example of a path search on the voice recognition dictionary in the voice recognition apparatus of the embodiment 2;

FIG. 10 is a flowchart showing another example of the voice recognition processing of the embodiment 2 and is a diagram showing a data example handled in the individual steps;

FIG. 11 is a diagram illustrating another example of the path search on the voice recognition dictionary in the voice recognition apparatus of the embodiment 2;

FIG. 12 is a block diagram showing a configuration of the voice recognition apparatus of an embodiment 3 in accordance with the present invention;

FIG. 13 is a diagram showing an example of a voice recognition dictionary in the embodiment 3;

FIG. 14 is a flowchart showing a flow of the voice recognition processing of the embodiment 3 and is a diagram showing a data example handled in the individual steps;

FIG. 15 is a block diagram showing a configuration of the voice recognition apparatus of an embodiment 4 in accordance with the present invention;

FIG. 16 is a diagram illustrating an example of a feature matrix used in the voice recognition apparatus of the embodiment 4;

FIG. 17 is a diagram illustrating another example of the feature matrix used in the voice recognition apparatus of the embodiment 4;

FIG. 18 is a flowchart showing a flow of the voice recognition processing of the embodiment 4 and is a diagram showing a data example handled in the individual steps;

FIG. 19 is a diagram illustrating a path search on the voice recognition dictionary in the voice recognition apparatus of the embodiment 4;

FIG. 20 is a block diagram showing a configuration of the voice recognition apparatus of an embodiment 5 in accordance with the present invention;

FIG. 21 is a diagram showing an example of a voice recognition dictionary composed of syllables used in the voice recognition apparatus of the embodiment 5;

FIG. 22 is a flowchart showing a flow of the creating processing of syllabified address data of the embodiment 5 and is a diagram showing a data example handled in the individual steps; and

FIG. 23 is a flowchart showing a flow of the voice recognition processing of the embodiment 5 and is a diagram showing a data example handled in the individual steps.

### BEST MODE FOR CARRYING OUT THE INVENTION

The best mode for carrying out the invention will now be described with reference to the accompanying drawings to explain the present invention in more detail.

### Embodiment 1

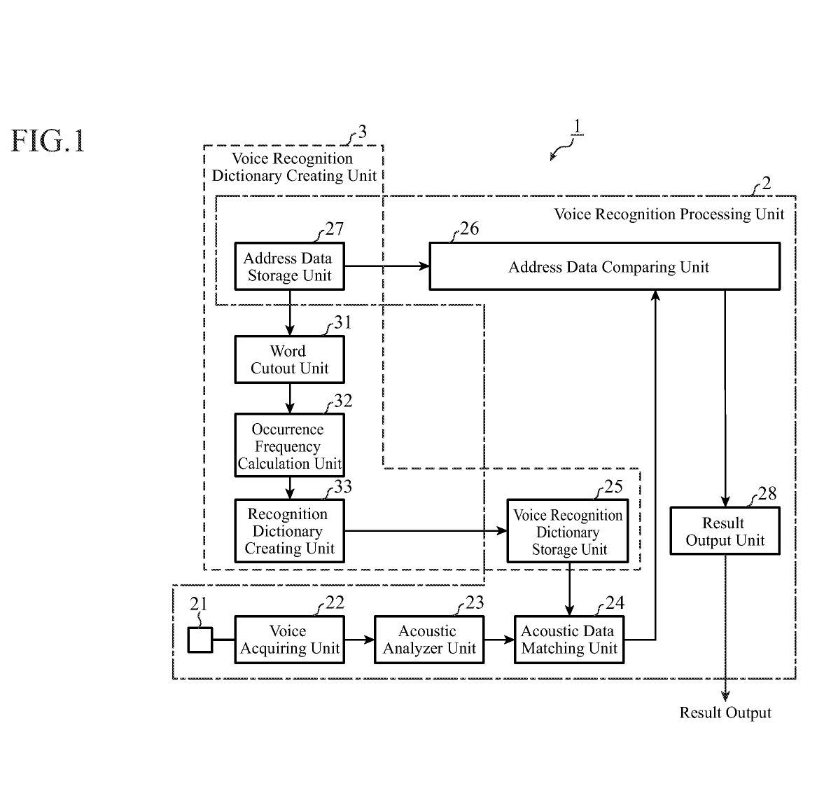

FIG. 1 is a block diagram showing a configuration of the voice recognition apparatus of an embodiment 1 in accordance with the present invention, which shows an apparatus for executing voice recognition of an address uttered by a user. In FIG. 1, the voice recognition apparatus 1 of the embodiment 1 comprises a voice recognition processing unit 2 and a voice recognition dictionary creating unit 3. The voice recognition processing unit 2, which is a component for executing voice recognition of the voice picked up with a microphone 21, comprises the microphone 21, a voice acquiring unit 22, an acoustic analyzer unit 23, an acoustic data matching unit 24, a voice recognition dictionary storage unit 25, an address data comparing unit 26, an address data storage unit 27 and a result output unit 28.

In addition, the voice recognition dictionary creating unit 3, which is a component for creating a voice recognition dictionary to be stored in the voice recognition dictionary storage unit 25, comprises the voice recognition dictionary storage unit 25 and address data storage unit 27 in common with the voice recognition processing unit 2, and comprises as additional components a word cutout unit 31, an occurrence frequency calculation unit 32 and a recognition dictionary creating unit 33.

As for a voice which a user utters to give an address, the microphone 21 picks it up, and the voice acquiring unit 22 converts it to a digital voice signal. The acoustic analyzer unit 23 carries out acoustic analysis of the voice signal output from the voice acquiring unit 22, and converts to a time series of acoustic features of the input voice. The acoustic data matching unit 24 compares the time series of acoustic features of the input voice acquired by the acoustic analyzer unit 23 with the voice recognition dictionary stored in the voice recognition dictionary storage unit 25, and outputs the most likely recognition result. The voice recognition dictionary storage unit 25 is a storage for storing the voice recognition dictionary expressed as a word network to be compared with the time series of acoustic features of the input voice. The address data comparing unit 26 carries out initial portion matching of the recognition result acquired by the acoustic data matching unit 24 with the address data stored in the address data storage unit 27. The address data storage unit 27 stores the address data providing the word string of the address which is a target of the voice recognition. The result output unit 28 receives the address data partially matched in the comparison by the address data comparing unit 26, and outputs the address the address data indicates as a final recognition result.

The word cutout unit 31 is a component for cutting out a word from the address data stored in the address data storage unit 27 which is a vocabulary storage unit. The occurrence frequency calculation unit 32 is a component for calculating the frequency of a word cut out by the word cutout unit 31. The recognition dictionary creating unit 33 creates a voice recognition dictionary of words with a high occurrence frequency (not less than a prescribed threshold), which is calculated by the occurrence frequency calculation unit 32, from among the words cut out by the word cutout unit 31, and stores them in the voice recognition dictionary storage unit 25.

Next, the operation will be described.

### (1) Creation of Voice Recognition Dictionary.

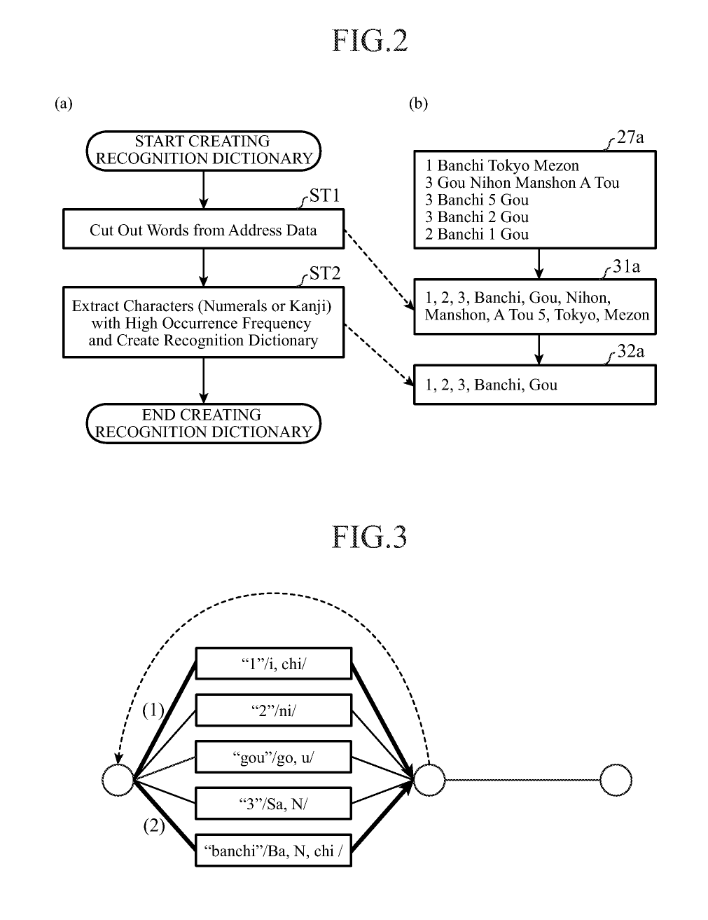

FIG. 2 is a flowchart showing a flow of the creating processing of the voice recognition dictionary in the embodiment 1 and is a diagram showing a data example handled in the individual steps: FIG. 2(a) shows the flowchart; and FIG. 2(b) shows the data example.

First, the word cutout unit 31 cuts out a word from the address data stored in the address data storage unit 27 (step ST1). For example, when the address data 27a as shown in FIG. 2(b) is stored in the address data storage unit 27, the word cutout unit 31 selects a word constituting an address shown by the address data 27a successively, and creates word list data 31a shown in FIG. 2(b).

Next, the occurrence frequency calculation unit 32 calculates the occurrence frequency of a word cut out by the word cutout unit 31. Among the words cut out by the word cutout unit 31, as for the words with the occurrence frequency not less than the prescribed threshold, which occurrence frequency is calculated by the occurrence frequency calculation unit 32, the recognition dictionary creating unit 33 creates the voice recognition dictionary. In the example of FIG. 2(b), the recognition dictionary creating unit 33 extracts the word list data 32a consisting of words “1”, “2”, “3”, “banchi (lot number)”, and “gou (house number)” with the occurrence frequency not less than the prescribed threshold “2” from the word list data 31a cut out by the word cutout unit 31, creates the voice recognition dictionary expressed in terms of a word network of the words extracted, and stores it in the voice recognition dictionary storage unit 25. The processing so far corresponds to step ST2.

FIG. 3 is a diagram showing an example of the voice recognition dictionary created by the recognition dictionary creating unit 33, which shows the voice recognition dictionary created from the word list data 32a shown in FIG. 2(b). As shown in FIG. 3, the voice recognition dictionary storage unit 25 stores a word network composed of the words with the occurrence frequency not less than the prescribed threshold and their Japanese reading. In the word network, the leftmost node denotes the state before executing the voice recognition, the paths starting from the node correspond to the words recognized, the node the paths enter corresponds to the state after the voice recognition, and the rightmost node denotes the state the voice recognition terminates. After the voice recognition of a word, if a further utterance to be subjected to the voice recognition is given, the processing returns to the leftmost node, and if no further utterance is given, the processing proceeds to the rightmost node. The words to be stored as a path are those with the occurrence frequency not less than the prescribed threshold, and words with the occurrence frequency less than the prescribed threshold, that is, words with a low frequency of use are not included in the voice recognition dictionary. For example, in the word list data 31a of FIG. 2(b), a proper name of a building such as “Nihon manshon” is excluded from a creating target of the voice recognition dictionary.

### (2) Voice Recognition Processing.

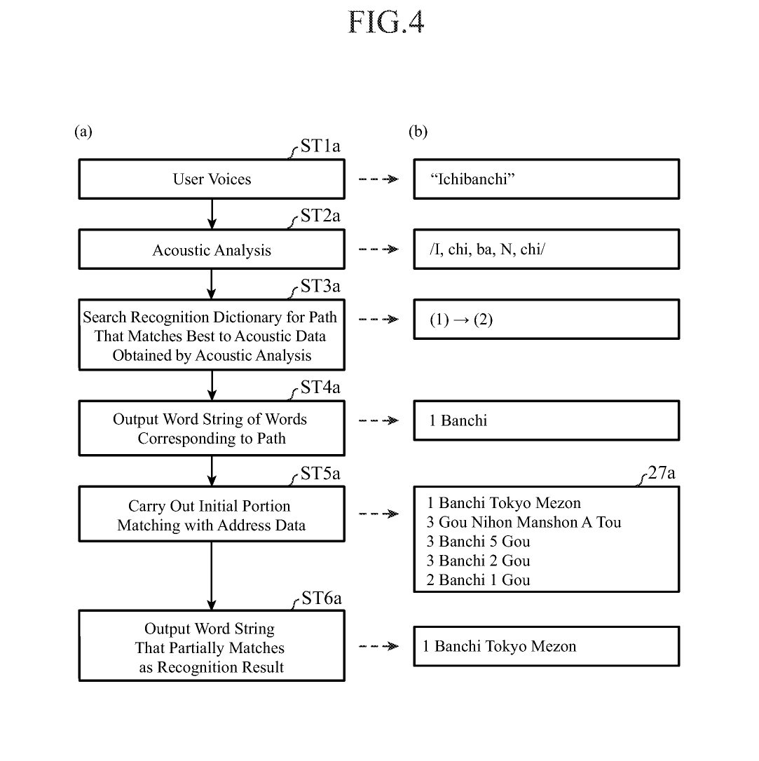

FIG. 4 is a flowchart showing a flow of the voice recognition processing of the embodiment 1 and is a diagram showing a data example handled in the individual steps: FIG. 4(a) shows the flowchart; and FIG. 4(b) shows the data example.

First, a user voices an address (step ST1a). Here, assume that the user voices “ichibanchi”, for example. The voice the user utters is picked up with the microphone 21, and is converted to a digital signal by the voice acquiring unit 22.

Next, the acoustic analyzer unit 23 carries out acoustic analysis of the voice signal converted to the digital signal by the voice acquiring unit 22, and converts to a time series (vector column) of acoustic features of the input voice (step ST2a). In the example shown in FIG. 4(b), /I, chi, ba, N, chi/ is acquired as the time series of acoustic features of the input voice “ichibanchi”.

After that, the acoustic data matching unit 24 compares the acoustic data of the input voice acquired as a result of the acoustic analysis by the acoustic analyzer unit 23 with the voice recognition dictionary stored in the voice recognition dictionary storage unit 25, and searches for the path that matches best to the acoustic data of the input voice from the word network recorded in the voice recognition dictionary (step ST3a). In the example shown in FIG. 4(b), from the word network of the voice recognition dictionary shown in FIG. 3, the path (1)—>(2), which matches best to /I, chi, ba, N, chi/ which is the acoustic data of the input voice, is selected as the search result.

After that, the acoustic data matching unit 24 extracts the word string corresponding to the path of the search result from the voice recognition dictionary, and supplies it to the address data comparing unit 26 (step ST4a). In FIG. 4(b), the word string “1 banchi” is supplied to the address data comparing unit 26.

Subsequently, the address data comparing unit 26 carries out initial portion matching between the word string acquired by the acoustic data matching unit 24 and the address data stored in the address data storage unit 27 (step ST5a). In FIG. 4(b), the address data 27a stored in the address data storage unit 27 and the word string acquired by the acoustic data matching unit 24 are subjected to the initial portion matching.

Finally, the address data comparing unit 26 selects the word string with its initial portion matching with the word string acquired by the acoustic data matching unit 24 from the word strings of the address data stored in the address data storage unit 27, and supplies it to the result output unit 28. Thus, the result output unit 28 outputs the word string with its initial portion matching with the word string acquired by the acoustic data matching unit 24 as the recognition result. The processing so far corresponds to step ST6a. Incidentally, in the example of FIG. 4(b), “1 banchi Tokyo mezon” is selected from the word strings of the address data 27a, and is output as the recognition result.

As described above, according to the present embodiment 1, it comprises: the acoustic analyzer unit 23 for carrying out acoustic analysis of the input voice signal and for converting to the time series of acoustic features; the address data storage unit 27 for storing the address data which is the words of the voice recognition target; the word cutout unit 31 for cutting out the word from the address data stored in the address data storage unit 27; the occurrence frequency calculation unit 32 for calculating the occurrence frequency of the word cut out by the word cutout unit 31; the recognition dictionary creating unit 33 for creating the voice recognition dictionary of the words with the occurrence frequency not less than the predetermined value, which occurrence frequency is calculated by the occurrence frequency calculation unit 32; the acoustic data matching unit 24 for comparing the time series of acoustic features of the input voice acquired by the acoustic analyzer unit 23 with the voice recognition dictionary created by the recognition dictionary creating unit 33, and for selecting the most likely word string as the input voice from the voice recognition dictionary; and the address data comparing unit 26 for carrying out partial matching between the word string selected by the acoustic data matching unit 24 and the words stored in the address data storage unit 27, and for selecting as the voice recognition result the word (word string) that partially matches to the word string selected by the acoustic data matching unit 24 from among the words stored in the address data storage unit 27.

With the configuration thus arranged, it can obviate the need for creating the voice recognition dictionary for all the words constituting the address and reduce the capacity required for the voice recognition dictionary. In addition, by reducing the number of words to be recorded in the voice recognition dictionary in accordance with the occurrence frequency (frequency of use), it can reduce the number of targets to be subjected to the matching processing with the acoustic data of the input voice, thereby being able to speed up the recognition processing. Furthermore, the initial portion matching between the word string, which is the result of the acoustic data matching, and the word string of the address data recorded in the address data storage unit 27 makes it possible to speed up the recognition processing while maintaining the reliability of the recognition result.

### Embodiment 2

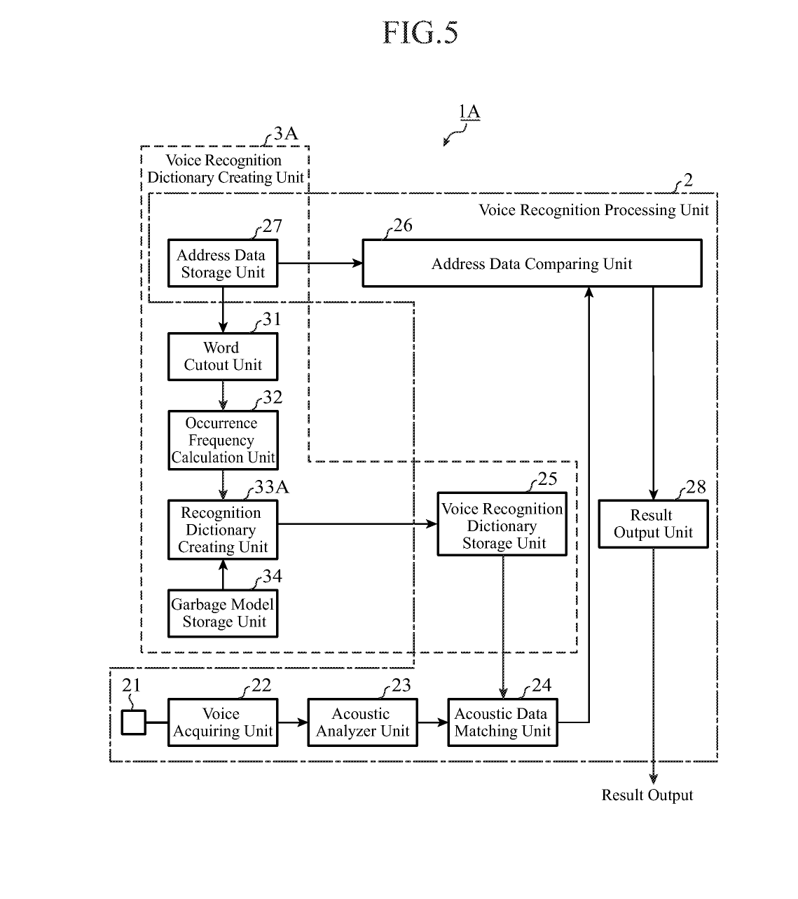

FIG. 5 is a block diagram showing a configuration of the voice recognition apparatus of an embodiment 2 in accordance with the present invention. In FIG. 5, the voice recognition apparatus 1A of the embodiment 2 comprises the voice recognition processing unit 2 and a voice recognition dictionary creating unit 3A. The voice recognition processing unit 2 has the same configuration as that of the foregoing embodiment 1. The voice recognition dictionary creating unit 3A comprises as in the foregoing embodiment 1 the voice recognition dictionary storage unit 25, address data storage unit 27, word cutout unit 31 and occurrence frequency calculation unit 32. In addition, as its proper components of the embodiment 2, it comprises a recognition dictionary creating unit 33A and a garbage model storage unit 34.

As for words with a high occurrence frequency (not less than a prescribed threshold) among the words cut out by the word cutout unit 31, which occurrence frequency is calculated by the occurrence frequency calculation unit 32, the recognition dictionary creating unit 33A creates a voice recognition dictionary of them, adds a garbage model readout of the garbage model storage unit 34 to them, and then stores in the voice recognition dictionary storage unit 25. The garbage model storage unit 34 is a storage for storing a garbage model. Here, the “garbage model” is an acoustic model which is output uniformly as a recognition result whatever the utterance may be.

Next, the operation will be described.

### (1) Creation of Voice Recognition Dictionary.

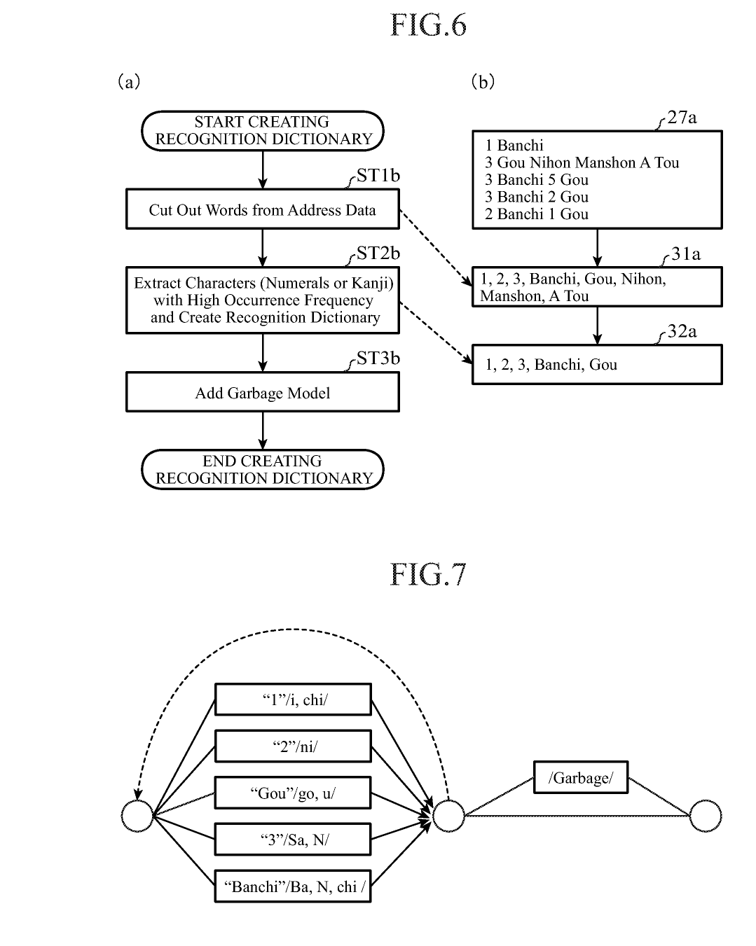

FIG. 6 is a flowchart showing a flow of the creating processing of the voice recognition dictionary in the embodiment 2 and is a diagram showing a data example handled in the individual steps: FIG. 6(a) shows the flowchart; and FIG. 6(b) shows the data example.

First, the word cutout unit 31 cuts out a word from the address data stored in the address data storage unit 27 (step ST1b). For example, when the address data 27a as shown in FIG. 6(b) is stored in the address data storage unit 27, the word cutout unit 31 selects a word constituting an address shown by the address data 27a successively, and creates word list data 31a shown in FIG. 6(b).

Next, the occurrence frequency calculation unit 32 calculates the occurrence frequency of a word cut out by the word cutout unit 31. Among the words cut out by the word cutout unit 31, as for the words with the occurrence frequency not less than the prescribed threshold, which occurrence frequency is calculated by the occurrence frequency calculation unit 32, the recognition dictionary creating unit 33A creates the voice recognition dictionary. In the example of FIG. 6(b), the recognition dictionary creating unit 33A extracts the wordlist data 32a consisting of words “1”, “2”, “3”, “banchi”, and “gou” with the occurrence frequency not less than the prescribed threshold “2” from the word list data 31a cut out by the word cutout unit 31, and creates the voice recognition dictionary expressed in terms of a word network of the words extracted. The processing so far corresponds to step ST2b.

After that, the recognition dictionary creating unit 33A adds the garbage model read out of the garbage model storage unit 34 to the word network in the voice recognition dictionary created at step ST2b, and stores in the voice recognition dictionary storage unit 25 (step ST3b).

FIG. 7 is a diagram showing an example of the voice recognition dictionary created by the recognition dictionary creating unit 33A, which shows the voice recognition dictionary created from the word list data 32a shown in FIG. 6(b). As shown in FIG. 7, the voice recognition dictionary storage unit 25 stores a word network composed of the words with the occurrence frequency not less than the prescribed threshold and their Japanese reading and the garbage model added to the word network. Thus, as in the foregoing embodiment 1, words with the occurrence frequency less than the prescribed threshold, that is, words with a low frequency of use are not included in the voice recognition dictionary. For example, in the word list data 31a of FIG. 6(b), a proper name of a building such as “Nihon manshon” is excluded from a creating target of the voice recognition dictionary. Incidentally, References 1-3 describe details of a garbage model. The present invention utilizes a garbage model described in References 1-3.

Reference 1: Japanese Patent Laid-Open No. 11-15492.

Reference 2: Japanese Patent Laid-Open No. 2007-17736.

Reference 3: Japanese Patent Laid-Open No. 2009-258369.

### (2) Voice Recognition Processing.

### (2-1) When Utterance Containing Only Words Recorded in Voice Recognition Dictionary is Given.

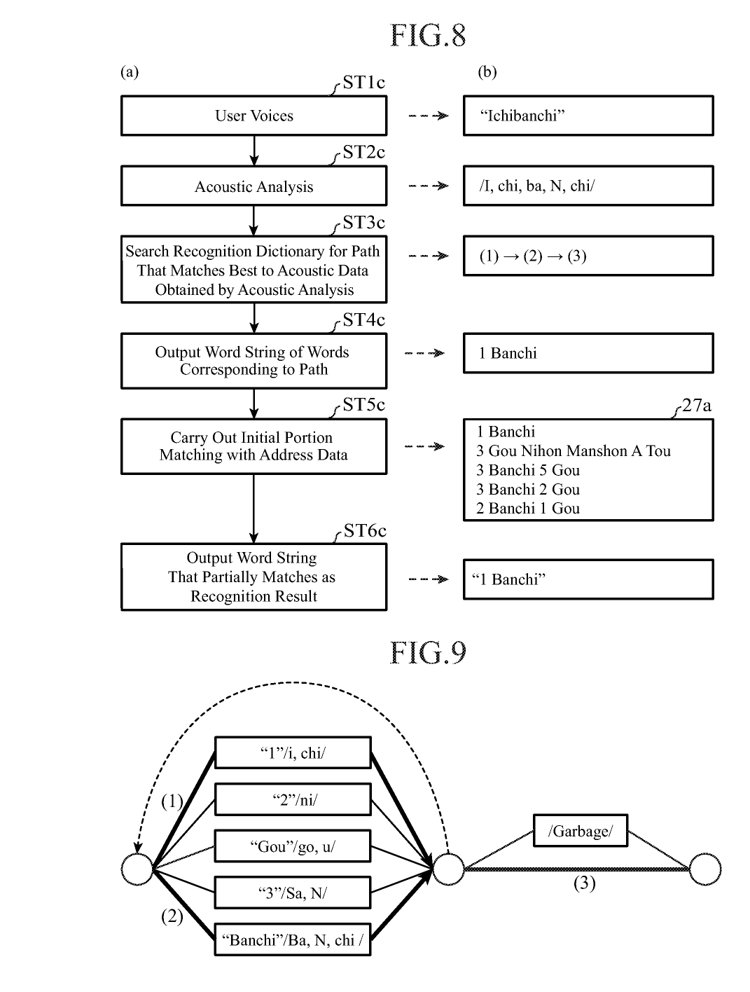

FIG. 8 is a flowchart showing a flow of the voice recognition processing of the embodiment 2 and is a diagram showing a data example handled in the individual steps: FIG. 8(a) shows the flowchart; and FIG. 8(b) shows the data example.

First, a user voices an address (step ST1c). Here, assume that the user voices “ichibanchi”, for example. The voice the user utters is picked up with the microphone 21, and is converted to a digital signal by the voice acquiring unit 22.

Next, the acoustic analyzer unit 23 carries out acoustic analysis of the voice signal converted to the digital signal by the voice acquiring unit 22, and converts to a time series (vector column) of acoustic features of the input voice (step ST2c). In the example shown in FIG. 8(b), /I, chi, ba, N, chi/ is acquired as the time series of acoustic features of the input voice “ichibanchi”.

After that, the acoustic data matching unit 24 compares the acoustic data of the input voice acquired as a result of the acoustic analysis by the acoustic analyzer unit 23 with the voice recognition dictionary stored in the voice recognition dictionary storage unit 25, and searches for the path that matches best to the acoustic data of the input voice from the word network recorded in the voice recognition dictionary (step ST3c).

In the example shown in FIG. 8(b), since it is an example containing only the words recorded in the voice recognition dictionary shown in FIG. 7, as shown in FIG. 9, the path (1)—>(2)—>(3) which matches best to /I, chi, ba, N, chi/ which is the acoustic data of the input voice is selected as the search result from the word network of the voice recognition dictionary shown in FIG. 7.

After that, the acoustic data matching unit 24 extracts the word string corresponding to the path of the search result from the voice recognition dictionary, and supplies it to the address data comparing unit 26 (step ST4c). In FIG. 8(b), the word string “1 banchi” is supplied to the address data comparing unit 26.

Subsequently, the address data comparing unit 26 carries out initial portion matching between the word string acquired by the acoustic data matching unit 24 and the address data stored in the address data storage unit 27 (step ST5c). In FIG. 8(b), the address data 27a stored in the address data storage unit 27 and the word string acquired by the acoustic data matching unit 24 are subjected to the initial portion matching.

Finally, the address data comparing unit 26 selects the word string with its initial portion matching with the word string acquired by the acoustic data matching unit 24 from the word strings of the address data stored in the address data storage unit 27, and supplies it to the result output unit 28. Thus, the result output unit 28 outputs the word string with its initial portion matching with the word string acquired by the acoustic data matching unit 24 as the recognition result. The processing so far corresponds to step ST6c. Incidentally, in the example of FIG. 8(b), “1 banchi” is selected from the word strings of the address data 27a, and is output as the recognition result.

### (2-2) When Utterance Containing Words Not Recorded in Voice Recognition Dictionary is Given.

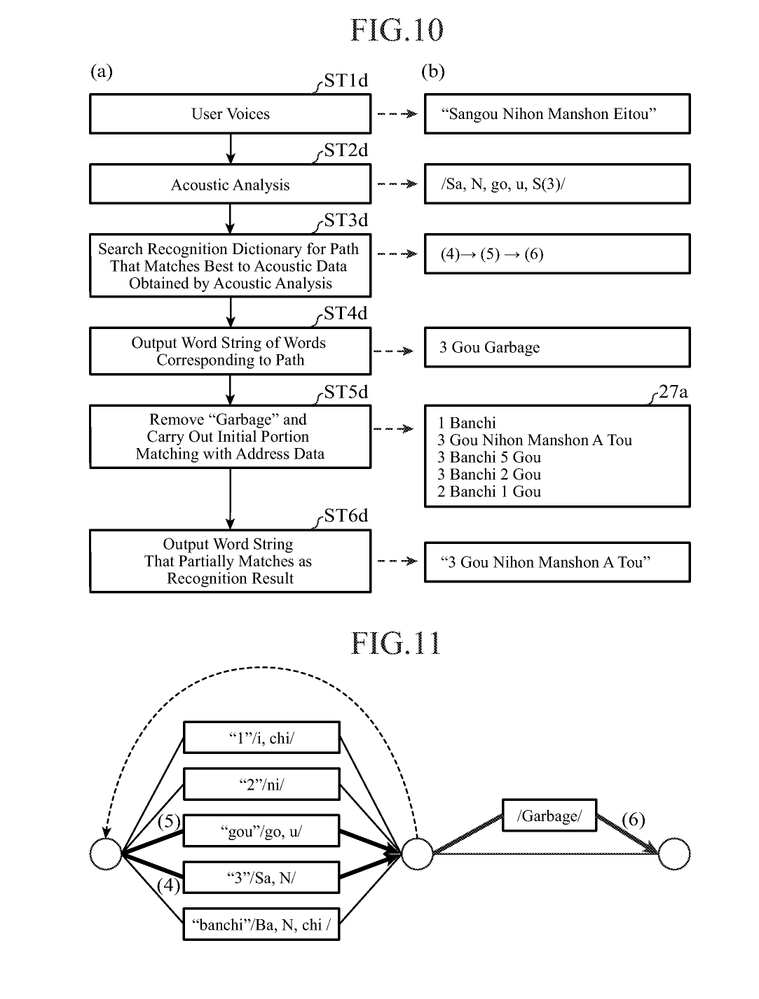

FIG. 10 is a flowchart showing a flow of the voice recognition processing of the utterance containing words not recorded in the voice recognition dictionary and is a diagram showing a data example handled in the individual steps: FIG. 10(a) shows the flowchart; and FIG. 10(b) shows the data example.

First, a user voices an address (step ST1d). Here, assume that the user voices “sangou nihon manshon eitou”, for example. The voice the user utters is picked up with the microphone 21, and is converted to a digital signal by the voice acquiring unit 22.

Next, the acoustic analyzer unit 23 carries out acoustic analysis of the voice signal converted to the digital signal by the voice acquiring unit 22, and converts to a time series (vector column) of acoustic features of the input voice (step ST2d). In the example shown in FIG. 10(b), /Sa, N, go, u, S(3)/ is acquired as the time series of acoustic features of the input voice “sangou nihon manshon eitou”. Here, S(n) is a notation representing that a garbage model is substituted for it, where n is the number of words of a character string whose reading cannot be decided.

After that, the acoustic data matching unit 24 compares the acoustic data of the input voice acquired as a result of the acoustic analysis by the acoustic analyzer unit 23 with the voice recognition dictionary stored in the voice recognition dictionary storage unit 25, and searches for the path that matches best to the acoustic data of the input voice from the word network recorded in the voice recognition dictionary (step ST3d).

In the example shown in FIG. 10(b), since it is an utterance containing words not recorded in the voice recognition dictionary shown in FIG. 7, as shown in FIG. 11, the path (4)—>(5) which matches best to /Sa, N, go, u/ which is the acoustic data of the input voice is searched for from among the word network of the voice recognition dictionary shown in FIG. 7, and as for the word string that does not contained in the voice recognition dictionary shown in FIG. 7, matching of the garbage model is made and the path (4)—>(5)—>(6) is selected as the search result.

After that, the acoustic data matching unit 24 extracts the word string corresponding to the path of the search result from the voice recognition dictionary, and supplies it to the address data comparing unit 26 (step ST4d). In FIG. 10(b), the word string “3 gou garbage” is supplied to the address data comparing unit 26.

Subsequently, the address data comparing unit 26 removes the “garbage” from the word string acquired by the acoustic data matching unit 24, and carries out initial portion matching between the word string and the address data stored in the address data storage unit 27 (step ST5d). In FIG. 10(b), the address data 27a stored in the address data storage unit 27 and the word string acquired by the acoustic data matching unit 24 undergo the initial portion matching.

Finally, the address data comparing unit 26 selects the word string with its initial portion matching with the word string, from which the “garbage” is removed, from the word strings of the address data stored in the address data storage unit 27, and supplies it to the result output unit 28. Thus, the result output unit 28 outputs the word string with its initial portion matching as the recognition result. The processing so far corresponds to step ST6d. Incidentally, in the example of FIG. 10(b), “3 gou Nihon manshon A tou” is selected from the word strings of the address data 27a, and is output as the recognition result.

As described above, according to the present embodiment 2, it comprises in addition to the configuration similar to the foregoing embodiment 1 the garbage model storage unit 34 for storing a garbage model, wherein the recognition dictionary creating unit 33A creates the voice recognition dictionary from the word network which is composed of the words with the occurrence frequency not less than the predetermined value plus the garbage model read out of the garbage model storage unit 34, which occurrence frequency is calculated by the occurrence frequency calculation unit 32; and the address data comparing unit 26 carries out partial matching between the word string, which is selected by the acoustic data matching unit 24 and from which the garbage model is removed, and the words stored in the address data storage unit 27, and employs the word (word string) that partially agrees with the word string, from which the garbage model is removed, as the voice recognition result among the words stored in the address data storage unit 27.

With the configuration thus arranged, it can obviate the need for creating the voice recognition dictionary for all the words constituting the address and reduce the capacity required for the voice recognition dictionary as in the foregoing embodiment 1. In addition, by reducing the number of words to be recorded in the voice recognition dictionary in accordance with the occurrence frequency (frequency of use), it can reduce the number of targets to be subjected to the matching processing with the acoustic data of the input voice, thereby being able to speed up the recognition processing. Furthermore, the initial portion matching between the word string, which is the result of the acoustic data matching, and the word string of the address data recorded in the address data storage unit 27 makes it possible to speed up the recognition processing while maintaining the reliability of the recognition result.

Incidentally, since the embodiment 2 adds the garbage model, it is not unlikely that a word to be recognized can be erroneously recognized as a garbage. The embodiment 2, however, has an advantage of being able to deal with a word not recorded while curbing the capacity of the voice recognition dictionary.

### Embodiment 3

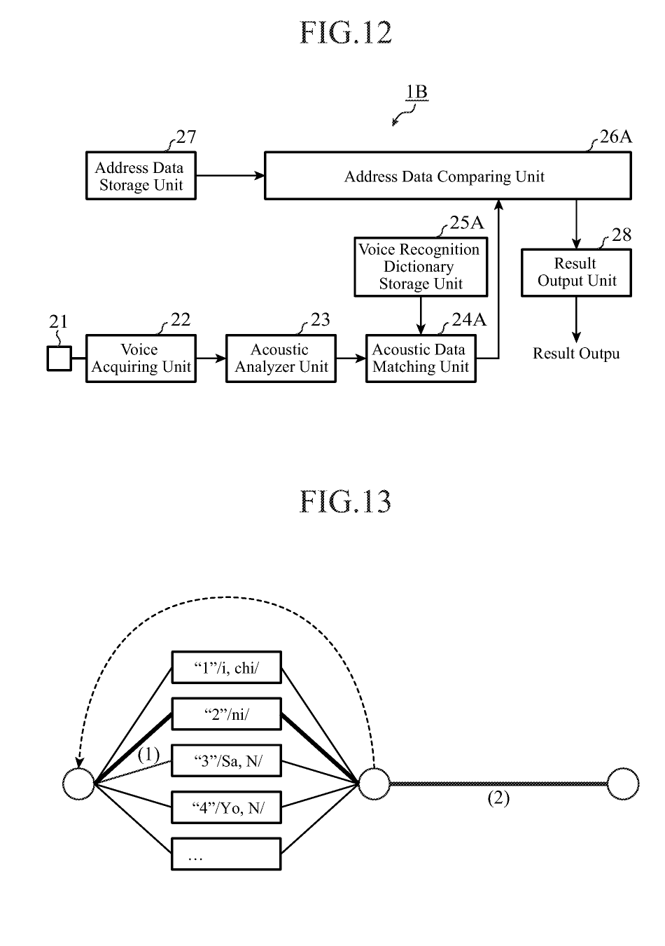

FIG. 12 is a block diagram showing a configuration of the voice recognition apparatus of an embodiment 3 in accordance with the present invention. In FIG. 12, components carrying out the same or like functions as the components shown in FIG. 1 are designated by the same reference numerals and their redundant description will be omitted. The voice recognition apparatus 1B of the embodiment 3 comprises the microphone 21, the voice acquiring unit 22, the acoustic analyzer unit 23, an acoustic data matching unit 24A, a voice recognition dictionary storage unit 25A, an address data comparing unit 26A, the address data storage unit 27, and the result output unit 28.

The acoustic data matching unit 24A compares the time series of acoustic features of the input voice acquired by the acoustic analyzer unit 23 with the voice recognition dictionary which contains only numerals stored in the voice recognition dictionary storage unit 25A, and outputs the most likely recognition result. The voice recognition dictionary storage unit 25A is a storage for storing the voice recognition dictionary expressed as a word (numeral) network to be compared with the time series of acoustic features of the input voice. Incidentally, as for creating the voice recognition dictionary consisting of only numerals constituting words of a certain category, an existing technique can be used. The address data comparing unit 26A is a component for carrying out initial portion matching of the recognition result of the numeral acquired by the acoustic data matching unit 24A with the numerical portion of the address data stored in the address data storage unit 27.

FIG. 13 is a diagram showing an example of the voice recognition dictionary in the embodiment 3. As shown in FIG. 13, the voice recognition dictionary storage unit 25A stores a word network composed of numerals and their Japanese reading. As shown, the embodiment 3 has the voice recognition dictionary consisting of only numerals that can be included in a word string representing an address, and does not require to create the voice recognition dictionary dependent on the address data. Accordingly, it does not need the word cutout unit 31, occurrence frequency calculation unit 32 and recognition dictionary creating unit 33 as the foregoing embodiment 1 or 2.

Next, the operation will be described.

Here, details of the voice recognition processing will be described.

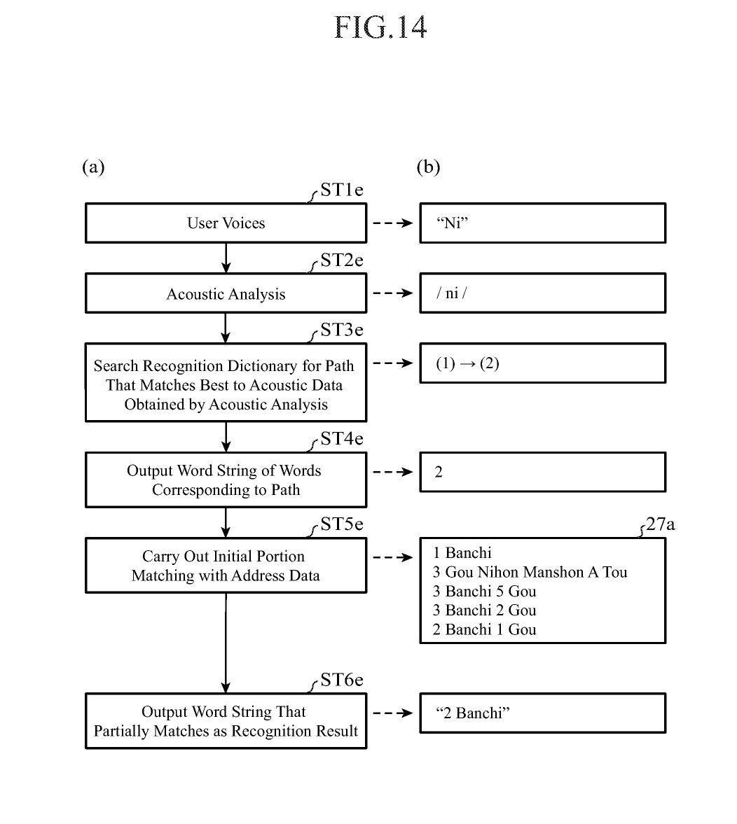

FIG. 14 is a flowchart showing a flow of the voice recognition processing of the embodiment 3 and is a diagram showing a data example handled in the individual steps: FIG. 14(a) shows the flowchart; and FIG. 14(b) shows the data example.

First, a user voices only a numerical portion of an address (step ST1e). In the example of FIG. 14(b), assume that the user voices “ni (two)”, for example. The voice the user utters is picked up with the microphone 21, and is converted to a digital signal by the voice acquiring unit 22.

Next, the acoustic analyzer unit 23 carries out acoustic analysis of the voice signal converted to the digital signal by the voice acquiring unit 22, and converts to a time series (vector column) of acoustic features of the input voice (step ST2e). In the example shown in FIG. 14(b), /ni/ is acquired as the time series of acoustic features of the input voice “ni”.

After that, the acoustic data matching unit 24A compares the acoustic data of the input voice acquired as a result of the acoustic analysis by the acoustic analyzer unit 23 with the voice recognition dictionary stored in the voice recognition dictionary storage unit 25A, and searches for the path that matches best to the acoustic data of the input voice from the word network recorded in the voice recognition dictionary (step ST3e).

In the example shown in FIG. 14(b), from the word network of the voice recognition dictionary shown in FIG. 13, the path (1)—>(2), which matches best to /ni/ which is the acoustic data of the input voice, is selected as the search result.

After that, the acoustic data matching unit 24A extracts the word string corresponding to the path of the search result from the voice recognition dictionary, and supplies it to the address data comparing unit 26A (step ST4e). In FIG. 14(b), the numeral “2” is supplied to the address data comparing unit 26A.

Subsequently, address data comparing unit 26A carries out initial portion matching between the word string (numeral string) acquired by the acoustic data matching unit 24A and the address data stored in the address data storage unit 27 (step ST5e). In FIG. 14(b), the address data 27a stored in the address data storage unit 27 and the numeral “2” acquired by the acoustic data matching unit 24A are subjected to the initial portion matching.

Finally, the address data comparing unit 26A selects the word string with its initial portion matching with the word string acquired by the acoustic data matching unit 24A from the word strings of the address data stored in the address data storage unit 27, and supplies it to the result output unit 28. Thus, the result output unit 28 outputs the word string with its initial portion matching with the word string acquired by the acoustic data matching unit 24A as the recognition result. The processing so far corresponds to step ST6e. In the example of FIG. 14(b), “2 banchi” is selected from the word strings of the address data 27a, and is output as the recognition result.

As described above, according to the present embodiment 3, it comprises: the acoustic analyzer unit 23 for carrying out acoustic analysis of the input voice signal and for converting to the time series of acoustic features; the address data storage unit 27 for storing the address data which is the words of the voice recognition target; the voice recognition dictionary storage unit 25A for storing the voice recognition dictionary consisting of numerals used as words of a prescribed category; the acoustic data matching unit 24A for comparing the time series of acoustic features of the input voice acquired by the acoustic analyzer unit 23 with the voice recognition dictionary read out of the voice recognition dictionary storage unit 25A, and selects the most likely word string from the voice recognition dictionary as the input voice; and the address data comparing unit 26 for carrying out partial matching between the word string selected by the acoustic data matching unit 24A and the words stored in the address data storage unit 27, and selects as the voice recognition result the word (word string) that partially matches to the word string selected by the acoustic data matching unit 24A from among the words stored in the address data storage unit 27. With the configuration thus arranged, it offers a further advantage of being able to obviate the need for creating the voice recognition dictionary that depends on the address data in advance in addition to the same advantages of the foregoing embodiments 1 and 2.

Incidentally, although the foregoing embodiment 3 shows the case that creates the voice recognition dictionary from a word network consisting of only numerals, a configuration is also possible which comprises the recognition dictionary creating unit 33 and the garbage model storage unit 34 as in the foregoing embodiment 2, and causes the recognition dictionary creating unit 33 to add a garbage model to the word network consisting of only numerals. In this case, it is not unlikely that a word to be recognized can be erroneously recognized as a garbage. The embodiment 3, however, has an advantage of being able to deal with a word not recorded while curbing the capacity of the voice recognition dictionary.

In addition, although the foregoing embodiment 3 shows the case that handles the voice recognition dictionary consisting of only the numerical portion of the address which is words of the voice recognition target, it can also handle a voice recognition dictionary consisting of words of a prescribed category other than numerals. As a category of words, there are personal names, regional and country names, the alphabet, and special characters in word strings constituting addresses which are voice recognition targets.

Furthermore, although the foregoing embodiments 1-3 show a case in which the address data comparing unit 26 carries out initial portion matching with the address data stored in the address data storage unit 27, the present invention is not limited to the initial portion matching. As long as it is partial matching, it can be intermediate matching or final portion matching.

### Embodiment 4

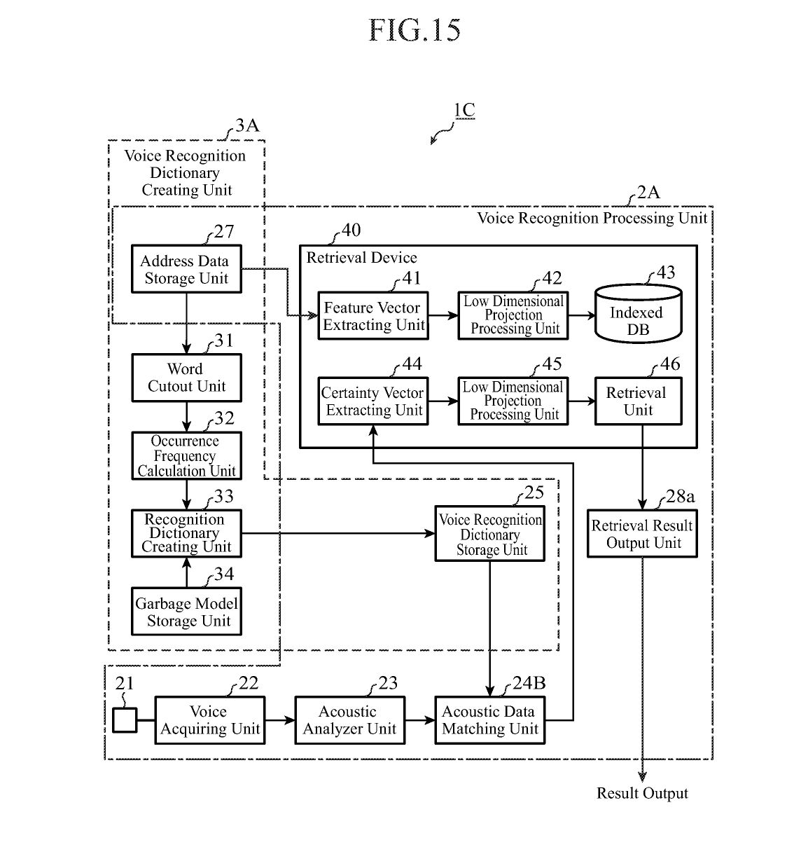

FIG. 15 is a block diagram showing a configuration of the voice recognition apparatus of an embodiment 4 in accordance with the present invention. In FIG. 15, the voice recognition apparatus 1C of the embodiment 4 comprises a voice recognition processing unit 2A and the voice recognition dictionary creating unit 3A. The voice recognition dictionary creating unit 3A has the same configuration as that of the foregoing embodiment 2. The voice recognition processing unit 2A comprises as in the foregoing embodiment 1 the microphone 21, voice acquiring unit 22, acoustic analyzer unit 23, voice recognition dictionary storage unit 25, and address data storage unit 27, and comprises as components unique to the embodiment 4 an acoustic data matching unit 24B, a retrieval device 40 and a retrieval result output unit 28a. The acoustic data matching unit 24B outputs a recognition result with a likelihood not less than a predetermined value as a word lattice. The term “word lattice” refers to a connection of one or more words that are recognized to have a likelihood not less than the predetermined value for the utterance, that match to the same acoustic feature and are arranged in parallel, and that are connected in series in the order of utterance.

The retrieval device 40 is a device that retrieves from the address data recorded in an indexed database 43 the most likely word string to the recognition result acquired by the acoustic data matching unit 24B by taking account of an error of the voice recognition, and supplies it to the retrieval result output unit 28a. It comprises a feature vector extracting unit 41, low dimensional projection processing units 42 and 45, the indexed database (abbreviated to “indexed DB” from now on) 43, a certainty vector extracting unit 44 and a retrieval unit 46. The retrieval result output unit 28a is a component for outputting the retrieval result by the retrieval device 40.

The feature vector extracting unit 41 is a component for extracting a document feature vector from a word string of an address designated by the address data stored in the address data storage unit 27. The term “document feature vector” refers to a feature vector that is used for searching for, by inputting a word into the Internet or the like, a Web page (document) relevant to the word, and that has, as its elements, weights corresponding to the occurrence frequency of the words for each document. The feature vector extracting unit 41 deals with the address data stored in the address data storage unit 27 as a document, and obtains the document feature vector having as its element the weight corresponding to the occurrence frequency of a word in the address data. A feature matrix that arranges the document feature vectors is a matrix W (the number of words M*the number of address data N) having as its elements the occurrence frequency wij of a word ri in address data dj. Incidentally, a word with a higher occurrence frequency is considered to be more important.

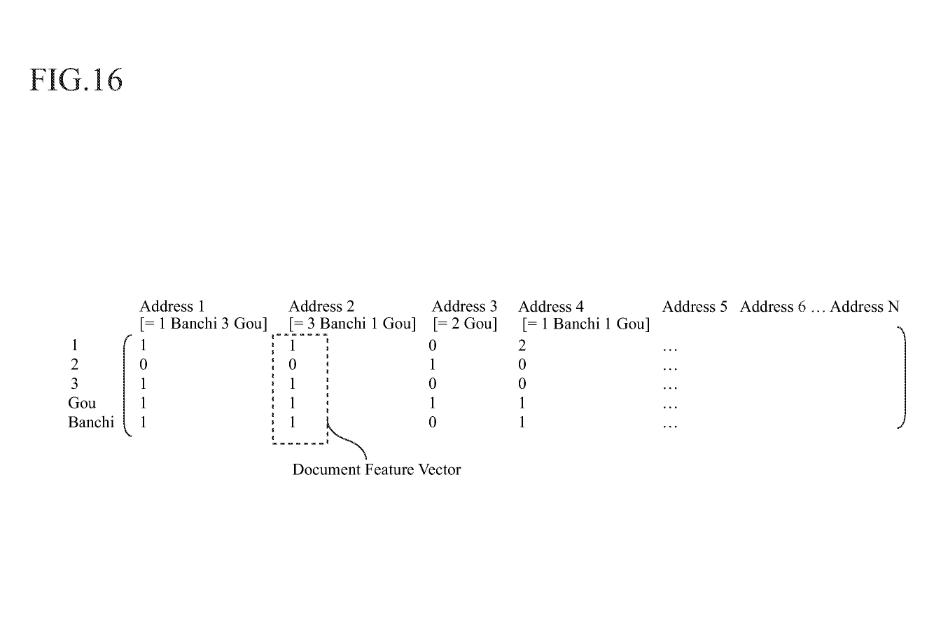

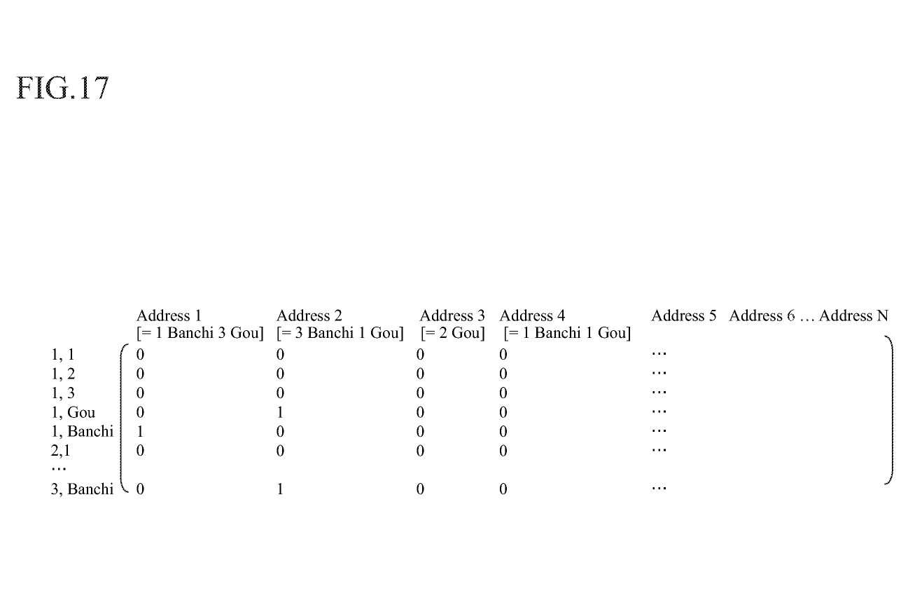

FIG. 16 is a diagram illustrating an example of the feature matrix used in the voice recognition apparatus of the embodiment 4. Here, although only “1”, “2”, “3”, “gou”, and “banchi” are shown as a word, the document feature vectors are defined in practice for words with the occurrence frequency in the address data not less than the predetermined value. As for the address data, since it is preferable to be able to distinguish “1 banchi 3 gou” from “3 banchi 1 gou”, it is also conceivable to define the document feature vector for a series of words. FIG. 17 is a diagram showing a feature matrix in such a case. In this case, the number of rows of the feature matrix becomes the square of the number of words M.

The low dimensional projection processing unit 42 is a component for projecting the document feature vector extracted by the feature vector extracting unit 41 onto a low dimensional document feature vector. The foregoing feature matrix W can generally be projected onto a lower feature dimension. For example, using a singular value decomposition (SVD) employed in Reference 4 makes it possible to carry out dimension compression to a prescribed feature dimension.

Reference 4: Japanese Patent Laid-Open No. 2004-5600.

The singular value decomposition (SVD) calculates a low dimensional feature vector as follows.

Assume that the feature matrix W is a t*d matrix with a rank r. In addition, assume that a t*r matrix that has t dimensional orthonormal vectors arranged by r columns is T; a d*r matrix that has d dimensional orthonormal vectors arranged by r columns is D; and an r*r diagonal matrix that has W singular values placed on the diagonal elements in descending order is S.

According to the singular value decomposition (SVD) theorem, W can be decomposed as the following Expression (1).

W_{t*d}=T_{t*r}S_{r*r}D_{d*r}^{T} (1)

Assume that matrices obtained by removing the (k+1)th column on and after from the T, S and D are denoted by T(k), S(k) and D(k). A matrix W(k), which is obtained by multiplying the matrix W by D(k)^{T} from the left and by transforming to k rows, is given by the following Expression (2).

W(k)_{k*d}=T(k)_{t*k}^{T}W_{t*d} (2)

Substituting the foregoing Expression (1) into the foregoing Expression (2) gives the following Expression (3) because T(k)^{T}T(k) is a unit matrix.

W(k)_{k*d}=S(k)_{k*k}D(k)_{d*k}^{T} (3)

A k dimensional vector corresponding to each column of W(k)_{k*d} calculated by the foregoing Expression (2) or the foregoing Expression (3) is a low dimensional feature vector representing the feature of each address data. W(k)_{k*d} becomes a k dimensional matrix that approximates W with the least error in terms of the Frobenius norm. The degree reduction bringing about k<r is an operation not only reducing the amount of calculation, but also a converting operation that relates in the abstract the words with documents using k conceptions, and has an advantage of being able to integrate similar words or similar documents.

In addition, according to the low dimensional document feature vector, the low dimensional projection processing unit 42 appends the low dimensional document feature vector to the address data stored in the address data storage unit 27 as an index, and records in the indexed DB 43.

The certainty vector extracting unit 44 is a component for extracting a certainty vector from the word lattice acquired by the acoustic data matching unit 24B. The term “certainty vector” refers to a vector that represents the probability that a word is actually voiced in a voice step in the same form as the document feature vector. The probability that a word is voiced in the voice step is a score of the path retrieved by the acoustic data matching unit 24B. For example, when a user voiced “hachi banchi” and if it is recognized that the probability of uttering the word “8 banchi” is 0.8 and the probability of uttering the word “1 banchi” is 0.6, the probability actually voiced becomes 0.8 for “8”, “0.6” for “1”, and 1 for “banchi”.

The low dimensional projection processing unit 45 obtains a low dimensional certainty vector corresponding to the low dimensional document feature vector by applying the same projection processing (multiplying T(k)_{t*k}^{T} from the left) as that applied to the document feature vector to the certainty vector extracted by the certainty vector extracting unit 44.

The retrieval unit 46 is a component for retrieving the address data having the low dimensional document feature vector that agrees with or is shortest in the distance to the low dimensional certainty vector acquired by the low dimensional projection processing unit 45 from the indexed DB 43. Here, the distance between the low dimensional certainty vector and the low dimensional document feature vector is the square root of the sum of squares of differences between the individual elements.

Next, the operation will be described.

Here, details of the voice recognition processing will be described.

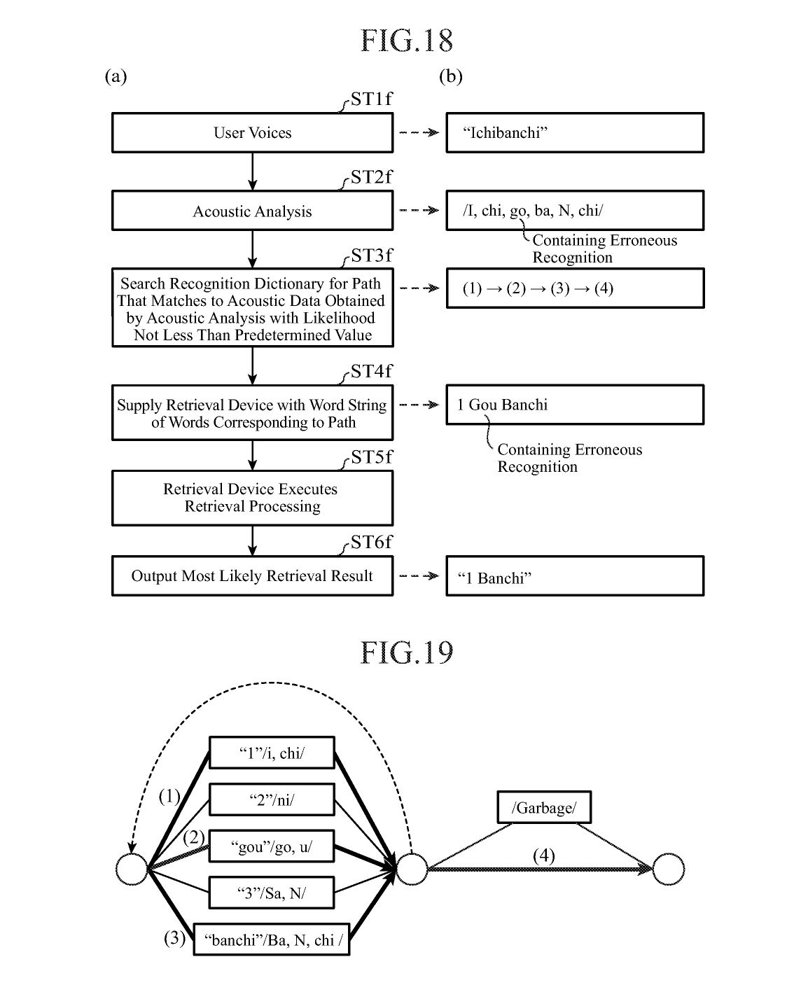

FIG. 18 is a flowchart showing a flow of the voice recognition processing of the embodiment 4 and is a diagram showing a data example handled in the individual steps: FIG. 18(a) shows the flowchart; and FIG. 18(b) shows the data example.

First, a user voices an address (step ST1f). In the example of FIG. 18(b), assume that the user voices “ichibanchi”. The voice the user utters is picked up with the microphone 21, and is converted to a digital signal by the voice acquiring unit 22.

Next, the acoustic analyzer unit 23 carries out acoustic analysis of the voice signal converted to the digital signal by the voice acquiring unit 22, and converts to a time series (vector column) of acoustic features of the input voice (step ST2f). In the example shown in FIG. 18(b), assume that /I, chi, go, ba, N, chi/, which contains an erroneous recognition, is acquired as the time series of acoustic features of the input voice “ichibanchi”.

After that, the acoustic data matching unit 24B compares the acoustic data of the input voice acquired as a result of the acoustic analysis by the acoustic analyzer unit 23 with the voice recognition dictionary stored in the voice recognition dictionary storage unit 25, and searches for the path that matches to the acoustic data of the input voice with a likelihood not less than the predetermined value from the word network recorded in the voice recognition dictionary (step ST3f).

As for the example of FIG. 18(b), from the word network of the voice recognition dictionary shown in FIG. 19, a path (1)—>(2)—>(3)—>(4) which matches to the acoustic data of the input voice “/I, chi, go, ba, N, chi/” with a likelihood not less than the predetermined value is selected as a search result. To simplify the explanation, it is assumed here that there is only one word string that has a likelihood not less than the predetermined value as the recognition result. This also applies to the following embodiment 5.

After that, the acoustic data matching unit 24B extracts the word lattice corresponding to the path of the search result from the voice recognition dictionary, and supplies it to the retrieval device 40 (step ST4f). In FIG. 18(b), the word string “1 gou banchi”, which contains an erroneous recognition, is supplied to the retrieval device 40.

The retrieval device 40 appends an index to the address data stored in the address data storage unit 27 in accordance with the low dimensional document feature vector in the address data, and stores the result to the indexed DB 43.

When the word lattice acquired by the acoustic data matching unit 24B is input, the certainty vector extracting unit 44 in the retrieval device 40 removes a garbage model from the input word lattice, and extracts a certainty vector from the remaining word lattice. Subsequently, the low dimensional projection processing unit 45 obtains a low dimensional certainty vector corresponding to the low dimensional document feature vector by executing the same projection processing as that applied to the document feature vector on the certainty vector extracted by the certainty vector extracting unit 44.

Subsequently, the retrieval unit 46 retrieves from the indexed DB 43 the word string of the address data having the low dimensional document feature vector that agrees with the low dimensional certainty vector of the input voice acquired by low dimensional projection processing unit 45 (step ST5f).

The retrieval unit 46 selects the word string of the address data having the low dimensional document feature vector that agrees with or is shortest in the distance to the low dimensional certainty vector of the input voice from the word string of the address data to be recorded in the indexed DB 43, and supplies to the retrieval result output unit 28a. Thus, the retrieval result output unit 28a outputs the word string of the input retrieval result as the recognition result. The processing so far corresponds to step ST6f. Incidentally, in the example of FIG. 18(b), “1 banchi” is selected from the word strings of the address data 27a and is output as the recognition result.

As described above, according to the present embodiment 4, it comprises: the acoustic analyzer unit 23 for carrying out acoustic analysis of the input voice signal and for converting to the time series of acoustic features; the address data storage unit 27 for storing the address data which is the words of the voice recognition target; the word cutout unit 31 for cutting out a word from the words stored in the address data storage unit 27; the occurrence frequency calculation unit 32 for calculating the occurrence frequency of the word cut out by the word cutout unit 31; the recognition dictionary creating unit 33 for creating the voice recognition dictionary of the words with the occurrence frequency not less than the predetermined value, which occurrence frequency is calculated by the occurrence frequency calculation unit 32; the acoustic data matching unit 24B for comparing the time series of acoustic features of the input voice acquired by the acoustic analyzer unit 23 with the voice recognition dictionary created by the recognition dictionary creating unit 33, and for selecting from the voice recognition dictionary the word lattice with the likelihood not less than the predetermined value as the input voice; and the retrieval device 40 which includes the indexed DB 43 that records the words stored in the address data storage unit 27 by relating them to their features, and which extracts the feature of the word lattice selected by the acoustic data matching unit 24B, retrieves from the indexed DB 43 the word with a feature that agrees with or is shortest in the distance to the feature extracted, and outputs it as the voice recognition result.

With the configuration thus arranged, it can provide a robust system capable of preventing an erroneous recognition that is likely to occur in the voice recognition processing such as an insertion of an erroneous word or an omission of a right word, thereby being able to improve the reliability of the system in addition to the advantages of the foregoing embodiments 1 and 2.

Incidentally, although the foregoing embodiment 4 shows the configuration that comprises the garbage model storage unit 34 and adds a garbage model to the word network of the voice recognition dictionary, a configuration is also possible which omits the garbage model storage unit 34 as the foregoing embodiment 1 and does not add a garbage model to the word network of the voice recognition dictionary. The configuration has a network without the part of “/Garbage/” in the word network shown in FIG. 19. In this case, although an acceptable utterance is limited to words in the voice recognition dictionary (that is, words with a high occurrence frequency), it is not necessary to create the voice recognition dictionary about all the words denoting the address as in the foregoing embodiment 1. Thus, the present embodiment 4 can reduce the capacity of the voice recognition dictionary and speed up the recognition processing as the result.

### Embodiment 5

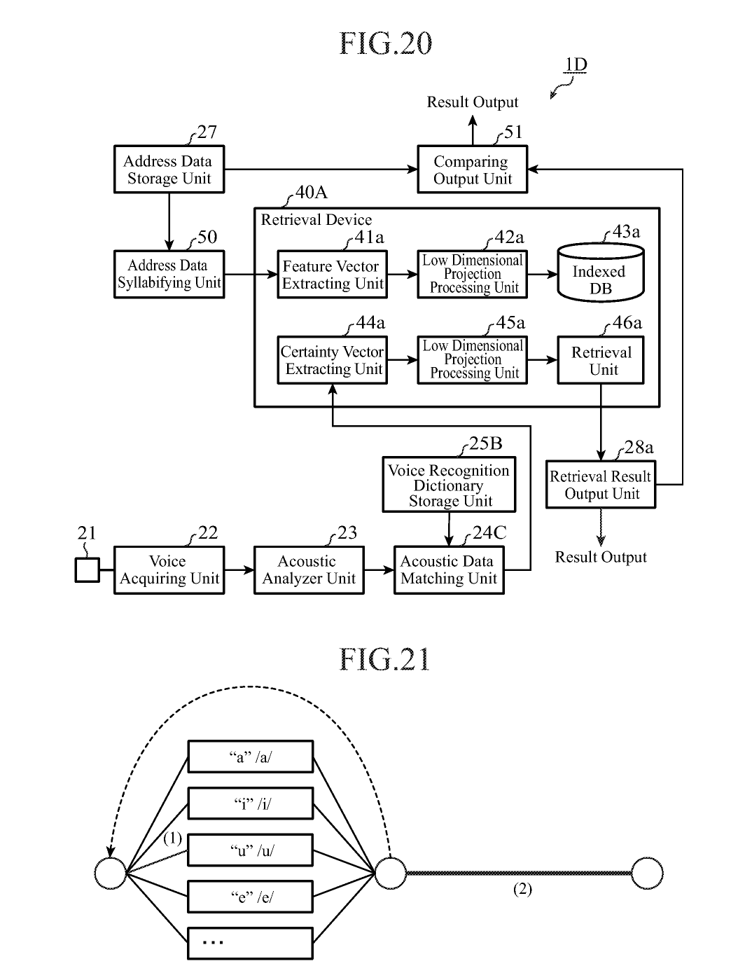

FIG. 20 is a block diagram showing a configuration of the voice recognition apparatus of an embodiment 5 in accordance with the present invention. In FIG. 20, components carrying out the same or like functions as the components shown in FIG. 1 and FIG. 15 are designated by the same reference numerals and their redundant description will be omitted.

The voice recognition apparatus 1D of the embodiment 5 comprises the microphone 21, the voice acquiring unit 22, the acoustic analyzer unit 23, an acoustic data matching unit 24C, a voice recognition dictionary storage unit 25B, a retrieval device 40A, the address data storage unit 27, the retrieval result output unit 28a, and an address data syllabifying unit 50.

The voice recognition dictionary storage unit 25B is a storage for storing the voice recognition dictionary expressed as a network of syllables to be compared with the time series of acoustic features of the input voice. The voice recognition dictionary is constructed in such a manner as to record a recognition dictionary network about all the syllables to enable recognition of all the syllables. Such a dictionary has been known already as a syllable typewriter.

The address data syllabifying unit 50 is a component for converting the address data stored in the address data storage unit 27 to a syllable sequence.

The retrieval device 40A is a device that retrieves, from the address data recorded in an indexed database, the address data with a feature that agrees with or is shortest in the distance to the feature of the syllable lattice which has a likelihood not less than a predetermined value as the recognition result acquired by the acoustic data matching unit 24C, and supplies to the retrieval result output unit 28a. It comprises a feature vector extracting unit 41a, low dimensional projection processing units 42a and 45a, an indexed DB 43a, a certainty vector extracting unit 44a, and a retrieval unit 46a. The retrieval result output unit 28a is a component for outputting the retrieval result of the retrieval device 40A.

The feature vector extracting unit 41a is a component for extracting a document feature vector from the syllable sequence of the address data acquired by the address data syllabifying unit 50. Here, the term “document feature vector” mentioned here refers to a feature vector having as its elements weights corresponding to the occurrence frequency of the syllables in the address data acquired by the address data syllabifying unit 50. Incidentally, its details are the same as those of the foregoing embodiment 4.

The low dimensional projection processing unit 42a is a component for projecting the document feature vector extracted by the feature vector extracting unit 41a onto a low dimensional document feature vector. The feature matrix W described above can generally be projected onto a lower feature dimension.

In addition, the low dimensional projection processing unit 42a employs the low dimensional document feature vector as an index, appends the index to the address data acquired by the address data syllabifying unit 50 and to its syllable sequence, and records in the indexed DB 43a.

The certainty vector extracting unit 44a is a component for extracting a certainty vector from the syllable lattice acquired by the acoustic data matching unit 24C. The term “certainty vector” mentioned here refers to a vector representing the probability that the syllable is actually uttered in the voice step in the same form as the document feature vector. The probability that the syllable is uttered is the score of the path searched for by the acoustic data matching unit 24C as in the foregoing embodiment 4.

The low dimensional projection processing unit 45a obtains the low dimensional certainty vector corresponding to the low dimensional document feature vector by performing the same projection processing as that applied to the document feature vector on the certainty vector extracted by the certainty vector extracting unit 44a.

The retrieval unit 46a is a component for retrieving the address data having the low dimensional document feature vector that agrees with or is shortest in the distance to the low dimensional certainty vector acquired from the indexed DB 43a by the low dimensional projection processing unit 45.

FIG. 21 is a diagram showing an example of the voice recognition dictionary in the embodiment 5. As shown in FIG. 21, the voice recognition dictionary storage unit 25B stores a syllable network consisting of syllables. Thus, the embodiment 5 has the voice recognition dictionary consisting of only syllables, and does not need to create the voice recognition dictionary dependent on the address data. Accordingly, it obviates the need for the word cutout unit 31, occurrence frequency calculation unit 32 and recognition dictionary creating unit 33 which are required in the foregoing embodiment 1 or 2.

Next, the operation will be described.

### (1) Syllabication of Address Data.

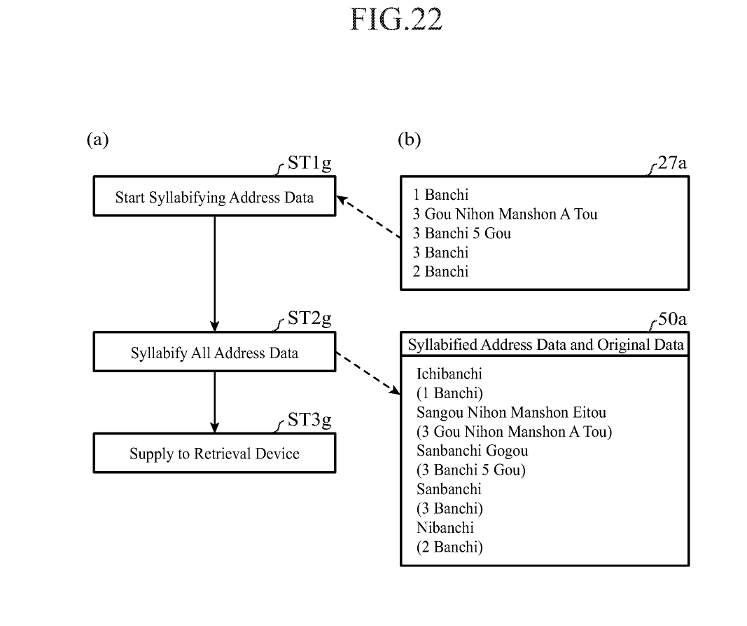

FIG. 22 is a flowchart showing a flow of the creating processing of the syllabified address data by the embodiment 5 and a diagram showing a data example handled in the individual steps: FIG. 22(a) shows a flowchart; and FIG. 22(b) shows a data example.

First, the address data syllabifying unit 50 starts reading the address data from the address data storage unit 27 (step ST1g). In the example shown in FIG. 22(b), the address data 27a is read out of the address data storage unit 27 and is taken into the address data syllabifying unit 50.

Next, the address data syllabifying unit 50 divides all the address data taken from the address data storage unit 27 into syllables (step ST2g). FIG. 22(b) shows the syllabified address data and the original address data as a syllabication result 50a. For example, the word string “1 banchi” is converted to a syllable sequence “/i/chi/ba/n/chi/”.

The address data syllabified by the address data syllabifying unit 50 is input to the retrieval device 40A (step ST3g). In the retrieval device 40A, according to the low dimensional document feature vector acquired by the feature vector extracting unit 41a, the low dimensional projection processing unit 42a appends an index to the address data and to its syllable sequence acquired by the address data syllabifying unit 50, and records them in the indexed DB 43a.

### (2) Voice Recognition Processing

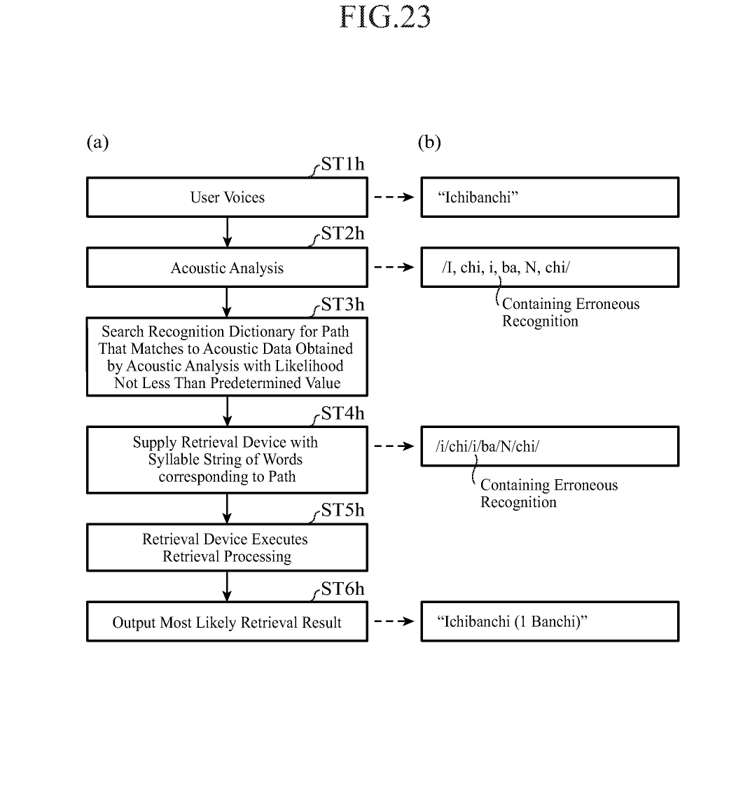

FIG. 23 is a flowchart showing a flow of the voice recognition processing of the embodiment 5 and is a diagram showing a data example handled in the individual steps: FIG. 23(a) shows the flowchart; and FIG. 23(b) shows the data example.

First, a user voices an address (step ST1h). In the example of FIG. 23(b), assume that the user voices “ichibanchi”. The voice the user utters is picked up with the microphone 21, and is converted to a digital signal by the voice acquiring unit 22.

Next, the acoustic analyzer unit 23 carries out acoustic analysis of the voice signal converted to the digital signal by the voice acquiring unit 22, and converts to a time series (vector column) of acoustic features of the input voice (step ST2h). In the example shown in FIG. 23(b), assume that /I, chi, ba, N, chi/, which contains an erroneous recognition, is acquired as the time series of acoustic features of the input voice “ichibanchi”.

After that, the acoustic data matching unit 24C compares the acoustic data of the input voice acquired as a result of the acoustic analysis by the acoustic analyzer unit 23 with the voice recognition dictionary consisting of the syllables stored in the voice recognition dictionary storage unit 25, and searches for the path that matches to the acoustic data of the input voice with a likelihood not less than the predetermined value from the syllable network recorded in the voice recognition dictionary (step ST3h).

In the example of FIG. 23(b), a path that matches to “/I, chi, i, ba, N, chi/”, which is the acoustic data of the input voice, with a likelihood not less than the predetermined value is selected from the syllable network of the voice recognition dictionary shown in FIG. 21 as a search result.

After that, the acoustic data matching unit 24C extracts the syllable lattice corresponding to the path of the search result from the voice recognition dictionary, and supplies it to the retrieval device 40A (step ST4h). In FIG. 23(b), the word string “/i/chi/i/ba/n/chi/”, which contains an erroneous recognition, is supplied to the retrieval device 40A.

As was described with reference to FIG. 22, the retrieval device 40A appends the low dimensional feature vector of the syllable sequence to the address data and to its syllable sequence as an index, and stores the result to the indexed DB 43a.

Receiving the syllable lattice of the input voice acquired by the acoustic data matching unit 24C, the certainty vector extracting unit 44a in the retrieval device 40A extracts the certainty vector from the syllable lattice received. Subsequently, the low dimensional projection processing unit 45a obtains the low dimensional certainty vector corresponding to the low dimensional document feature vector by performing the same projection processing as that applied to the document feature vector on the certainty vector extracted by the certainty vector extracting unit 44a.

Subsequently, the retrieval unit 46a retrieves from the indexed DB 43a the address data and its syllable sequence having the low dimensional document feature vector that agrees with or is shortest in the distance to the low dimensional certainty vector of the input voice acquired by the low dimensional projection processing unit 45a (step ST5h).

The retrieval unit 46a selects from the address data recorded in the indexed DB 43a the address data having the low dimensional document feature vector that agrees with or is shortest in the distance to the low dimensional certainty vector of the input voice, and supplies the address data to the retrieval result output unit 28a. The processing so far corresponds to step ST6h. In the example of FIG. 23(b), “ichibanchi (1 banchi)” is selected and is output as the recognition result.

As described above, according to the present embodiment 5, it comprises: the acoustic analyzer unit 23 for carrying out acoustic analysis of the input voice signal and for converting to the time series of acoustic features; the address data storage unit 27 for storing the address data which is the words of the voice recognition target; the address data syllabifying unit 50 for converting the words stored in the address data storage unit 27 to the syllable sequence; the voice recognition dictionary storage unit 25B for storing the voice recognition dictionary consisting of syllables; the acoustic data matching unit 24C for comparing the time series of acoustic features of the input voice acquired by the acoustic analyzer unit 23 with the voice recognition dictionary read out of the voice recognition dictionary storage unit 25B, and selects the syllable lattice with a likelihood not less than the predetermined value as the input voice from the voice recognition dictionary; the retrieval device 40A which comprises the indexed DB 43a that records the address data using as the index the low dimensional feature vector of the syllable sequence of the address data passing through the conversion by the address data syllabifying unit 50, and which extracts the feature of the syllable lattice selected by the acoustic data matching unit 24C and retrieves from the indexed DB 43a the word (address data) with a feature that agrees with the feature extracted; and a comparing output unit 51 for comparing the syllable sequence of the word retrieved by the retrieval device 40A with the words stored in the address data storage unit 27, and for outputting the word corresponding to the word retrieved by the retrieval device 40A as the voice recognition result from the words stored in the address data storage unit 27.

With the configuration thus arranged, since the present embodiment 5 can execute the voice recognition processing on a syllable by syllable basis, it offers in addition to the advantages of the foregoing embodiments 1 and 2 an advantage of being able to obviate the need for preparing the voice recognition dictionary dependent on the address data in advance. Besides, it can provide a robust system capable of preventing an erroneous recognition that is likely to occur in the voice recognition processing such as an insertion of an erroneous syllable or an omission of a right syllable, thereby being able to improve the reliability of the system.

In addition, although the foregoing embodiment 5 shows the case that creates the voice recognition dictionary from a syllable network, a configuration is also possible which comprises the recognition dictionary creating unit 33 and the garbage model storage unit 34 as in the foregoing embodiment 2, and allows the recognition dictionary creating unit 33 to add a garbage model to the network based on syllables. In this case, it is not unlikely that a word to be recognized can be erroneously recognized as a garbage. The embodiment 5, however, has an advantage of being able to deal with a word not recorded while curbing the capacity of the voice recognition dictionary.

Furthermore, a navigation system incorporating one of the voice recognition apparatuses of the foregoing embodiment 1 to embodiment 5 can reduce the capacity of the voice recognition dictionary and speedup the recognition processing in connection with that when inputting a destination or starting spot using the voice recognition in the navigation processing.

Although the foregoing embodiments 1-5 show a case where the target of the voice recognition is an address, the present invention is not limited to it. For example, it is also applicable to words which are a recognition target in various voice recognition situations such as any other settings in the navigation processing, a setting of a piece of music, or playback control in audio equipment.

Incidentally, it is to be understood that a free combination of the individual embodiments, or variations or removal of any components of the individual embodiments are possible within the scope of the present invention.

### INDUSTRIAL APPLICABILITY

A voice recognition apparatus in accordance with the present invention can reduce the capacity of the voice recognition dictionary and speed up the recognition processing. Accordingly, it is suitable for the voice recognition apparatus of an onboard navigation system that requires quick recognition processing.

### DESCRIPTION OF REFERENCE NUMERALS

1, 1A, 1B, 1C, 1D voice recognition apparatus; 2 voice recognition processing unit; 3, 3A voice recognition dictionary creating unit; 21 microphone; 22 voice acquiring unit; 23 acoustic analyzer unit; 24, 24A, 24B, 24C acoustic data matching unit; 25, 25A, 25B voice recognition dictionary storage unit; 26, 26A address data comparing unit; 27 address data storage unit; 27a address data; 28, 28a retrieval result output unit; 31 word cutout unit; 31a, 32a word list data; 32 occurrence frequency calculation unit; 33, 33A recognition dictionary creating unit; 34 garbage model storage unit; 40, 40A retrieval device; 41, 41a feature vector extracting unit; 42, 45, 42a, 45a low dimensional projection processing unit; 43, 43a indexed database (indexed DB); 44, 44a certainty vector extracting unit; 46, 46a retrieval unit; 50 address data syllabifying unit; 50a result of syllabication.

1.-3. (canceled)

4. A voice recognition apparatus comprising:
an acoustic analyzer unit for carrying out acoustic analysis of an input voice signal to convert the input voice signal to a time series of acoustic features;
a vocabulary storage unit for recording words which are a voice recognition target;
a dictionary storage unit for storing a voice recognition dictionary composed of a prescribed category of words;
an acoustic data matching unit for comparing the time series of acoustic features of the input voice acquired by the acoustic analyzer unit with the voice recognition dictionary read out of the dictionary storage unit, and for selecting a most likely word string as the input voice from the voice recognition dictionary; and
a partial matching unit for carrying out partial matching between the word string selected by the acoustic data matching unit and the words the vocabulary storage unit stores, and for selecting as a voice recognition result a word that partially matches to the word string selected by the acoustic data matching unit from among the words the vocabulary storage unit stores.

5. The voice recognition apparatus according to claim 4, wherein the prescribed category of words is a numeral.

6. The voice recognition apparatus according to claim 4, further comprising:
a garbage model storage unit for storing a garbage model; and
a recognition dictionary creating unit for creating the voice recognition dictionary composed of a word network which consists of the prescribed category of words and to which the garbage model read out of the garbage model storage unit is added, and for storing the voice recognition dictionary in the dictionary storage unit, wherein
the partial matching unit carries out partial matching between the word string which is selected by the acoustic data matching unit and is deprived of the garbage model and the words the vocabulary storage unit stores, and selects as the voice recognition result a word that partially matches to the word string, from which the garbage model is removed, from among the words the vocabulary storage unit stores.

7. A voice recognition apparatus comprising:
an acoustic analyzer unit for carrying out acoustic analysis of an input voice signal to convert the input voice signal to a time series of acoustic features;
a vocabulary storage unit for recording words which are a voice recognition target;
a word cutout unit for cutting out a word from the words stored in the vocabulary storage unit;
an occurrence frequency calculation unit for calculating an occurrence frequency of the word cut out by the word cutout unit;
a recognition dictionary creating unit for creating a voice recognition dictionary of words with the occurrence frequency not less than a predetermined value, the occurrence frequency being calculated by the occurrence frequency calculation unit;
an acoustic data matching unit for comparing the time series of acoustic features of the input voice acquired by the acoustic analyzer unit with the voice recognition dictionary created by the recognition dictionary creating unit, and for selecting from the voice recognition dictionary a word lattice with a likelihood not less than a predetermined value as the input voice; and
a retrieval device which includes a database that records the words stored in the vocabulary storage unit in connection with features of the words, and which extracts a feature of the word lattice selected by the acoustic data matching unit, searches the database for a word with a feature that agrees with or is shortest in a distance to the feature of the word lattice, and outputs the word as a voice recognition result.

8. The voice recognition apparatus according to claim 7, further comprising:
a garbage model storage unit for storing a garbage model, wherein
the recognition dictionary creating unit creates the voice recognition dictionary by adding a garbage model read out of the garbage model storage unit to a word network consisting of words with the occurrence frequency not less than a predetermined value, the occurrence frequency being calculated by the occurrence frequency calculation unit; and
the retrieval device extracts a feature by removing the garbage model from the word lattice selected by the acoustic data matching unit, and outputs as a voice recognition result a word with a feature that agrees with or is shortest in a distance to the feature of the word lattice, from which the garbage model is removed, from among the words recorded in the database.

9. A voice recognition apparatus comprising:
an acoustic analyzer unit for carrying out acoustic analysis of an input voice signal to convert the input voice signal to a time series of acoustic features;
a vocabulary storage unit for recording words which are a voice recognition target;
a syllabifying unit for converting the words stored in the vocabulary storage unit to a syllable sequence;
a dictionary storage unit for storing a voice recognition dictionary consisting of syllables;
an acoustic data matching unit for comparing the time series of acoustic features of the input voice acquired by the acoustic analyzer unit with the voice recognition dictionary read out of the dictionary storage unit, and for selecting from the voice recognition dictionary a syllable lattice with a likelihood not less than a predetermined value as the input voice; and
a retrieval device which includes a database that records the words stored in the vocabulary storage unit in connection with features of the words, and which extracts a feature of the syllable lattice selected by the acoustic data matching unit, searches the database for a word with a feature that agrees with or is shortest in a distance to the feature of the syllable lattice, and outputs the word as a voice recognition result.

10. The voice recognition apparatus according to claim 9, further comprising:
a garbage model storage unit for storing a garbage model; and
a recognition dictionary creating unit for creating the voice recognition dictionary composed of a syllable network to which the garbage model read out of the garbage model storage unit is added, and for storing the voice recognition dictionary in the dictionary storage unit, wherein
the retrieval device extracts a feature by removing the garbage model from the word lattice selected by the acoustic data matching unit, and outputs as a voice recognition result a word with a feature that agrees with or is shortest in a distance to the feature of the syllable lattice, from which the garbage model is removed, from among the words recorded in the database.

11. A navigation system comprising the voice recognition apparatus as defined in claim 4.

12. A navigation system comprising the voice recognition apparatus as defined in claim 7.

13. A navigation system comprising the voice recognition apparatus as defined in claim 9.
